(19) United States
(12) Patent Application Publication
(10) Pub. No.: US 2006/0288883 A1
(43) Pub. Date: Dec. 28, 2006

(54) Isostatic press comprising a maximum pressure indicating device and such a device

(75) Inventor: Nils-Gunnar Lonneborg, Vasteras (SE)

Correspondence Address: HARNESS, DICKEY & PIERCE, P.L.C., P.O. BOX 8910, RESTON, VA, 20195, US

(73) Assignee: Avure Technologies AB, Vasteras (SE)

(21) Appl. No.: 10/548,142

(22) PCT Filed: Feb. 12, 2004
(86) PCT No.: PCT/SE04/00181

§ 371 Date: Sep. 6, 2005

(30) Foreign Application Priority Data
Mar. 6, 2003 (SE) 0300595-6

(51) Int. Cl. B30B 9/30

(52) U.S. Cl. 100/99

(57) ABSTRACT

An isostatic press is disclosed, which includes a pressure chamber adapted to be pressurized by a pressure medium, and a measuring element which is placed so as to be subjected to the same pressure as the pressure chamber. The measuring element is arranged to present, after a pressing operation, independently of electric peripheral equipment, a remaining readable indication of the maximum value of the pressure achieved in the pressure chamber. The measuring element for measuring pressures in an isostatic press is also disclosed.

This application is the national phase under 35 U.S.C. § 371 of PCT International Application No. PCT/SE2004/000181 which has an International filing date of Feb. 12, 2004, which designated the United States of America and which claims priority on Swedish Patent Application number 0300595-6 filed Mar. 6, 2003.

### FIELD

The present invention generally relates to an isostatic press. For example, it may relate to one which includes a pressure chamber adapted to be pressurized by a pressure medium, such as a liquid, and a measuring element which is placed so as to be subjected to the same pressure as the pressure chamber. The invention also relates to a device for measuring pressures in such an isostatic press.

### BACKGROUND ART

Isostatic presses of the type mentioned by way of introduction have a plurality of well-known ranges of application; they are used, for instance, to compact different types of powder material into molded products. Another well-known range of application is isostatic high-pressure treatment of foods. The treatment aims at inactivating microorganisms and undesirable enzyme activity. The advantages of isostatic high pressure treatment of foods compared with traditional heat treatment are, inter alia, better preservation of natural flavors, scents and nutritive substances and also reduced process times. The pressure to which the foods are subjected typically amounts to between about 4,000 bar and about 10,000 bar. However, also other pressures can be applied in isostatic presses, such as 500-25,000 bar.

An isostatic press usually includes a pressure chamber where the product or the batch (production batch) that is to be subjected to pressure is placed. A pressure medium, typically a liquid or a gas, is supplied to the pressure chamber for pressurizing the pressure chamber.

It is in many cases desirable to be able to measure the pressure in a pressing operation. For foods, for example, pressure is an important parameter that affects the reduction of undesirable organisms in the foods that are subjected to high pressure treatment.

Today, the pressure in a pressing operation in isostatic presses is usually measured by way of a sensor which is based on the strain gauge technique and connected to the press. The sensor emits an electric signal that can be read as a pressure measurement or pressure indication of the pressure arising in the pressure chamber in a pressing operation. This type of pressure measurement allows continuous indication of the pressure in the isostatic press during the pressing operation and is used mainly to control and regulate the pressing operation. However, drawbacks of this type of measuring equipment are that it is dependent on functioning electric equipment and that it is fixedly mounted in connection with the press. The latter makes it difficult to move the measuring equipment between different isostatic presses.

Although existing devices and methods for pressure measurement are useable in spite of the above drawbacks, it may be desirable to have a supplement or an alternative to them in order to increase the reliability of the pressing operation.

### SUMMARY

An object of at least one embodiment of the present invention is to provide a supplement to existing solutions for pressure measurement in connection with isostatic pressing.

According to a first aspect of at least one embodiment of the invention, there is provided an isostatic press, comprising a pressure chamber adapted to be pressurized by a pressure medium, and a measuring element which is placed so as to be subjected to the same pressure as the pressure chamber. The measuring element is arranged to present, after a pressing operation, independently of electric peripheral equipment, a remaining readable indication of the maximum value of the pressure achieved in the pressure chamber.

At least one embodiment of the invention is based on a knowledge that, by providing a measuring element which is arranged to present, after a pressing operation, independently of electric peripheral equipment, a remaining readable indication of the maximum value of the pressure achieved in the pressure chamber of the isostatic press, it is possible to get a confirmation that a certain pressure has actually been achieved during the pressure treatment.

Thus, a supplement to traditional continuous measuring of pressures in isostatic presses is obtained by a measuring element which according to at least one embodiment of the invention enables subsequent reading and verification of the maximum value of the pressure achieved in a pressing operation. It is desirable to verify the maximum value of the pressure arisen in a pressing operation, for instance, for the purpose of guaranteeing the quality of the pressed material or, when foods are involved, ensuring that the amount of microorganisms in the foods has been reduced to a desirable degree during the pressing operation.

The measuring element according to at least one embodiment of the invention presents a readable indication of the maximum pressure independently of electric peripheral equipment, i.e. the measuring element need not be connected to, for instance, a computer or other electric peripheral equipment to allow reading. Instead, the maximum pressure can be indicated by, for instance, a geometric change of the measuring element. Thus, the measuring element can preferably be made entirely mechanical, thus making it easy and inexpensive to manufacture. The measuring element can also be made easy to use and read.

The measuring element according to at least one embodiment of the invention is preferably placed inside the pressure chamber, but can also be placed in a space outside the pressure chamber, provided that the space is in fluid communication with the pressure chamber. However, it is essential for the measuring element to be placed so that in a pressing operation it is subjected to the same pressure as the pressure chamber and, thus, the same pressure as the pressure to which the product or the batch is to be subjected in the pressure treatment. The positioning of the measuring element allows it to be in direct contact with the pressure medium in a pressing operation. In other words, there is nothing between the measuring element and the pressure medium that could affect the measurement of pressure, which in turn enables a more correct measurement.

The measuring element is, in the space where it is placed, arranged by way of a fixing device or holder. The holder should protect the measuring element from being affected by the product that is pressurized, but at the same time allow the measuring element to come into contact with the pressure medium. Since the measuring element is to be placed in the holder before a pressing operation and be removed and read after the pressing operation, the holder should allow easy insertion and removal of the measuring element. Preferably, the holder is a pipe or a cage, in which the measuring element is placed.

Preferably, the measuring element is arranged to present a visual indication of the maximum value of the pressure achieved in the pressure chamber, that is to say a noticeable indication of a change of pressure, which indication can be seen and read by, for example, an operator. For example, a geometric change or a change of position of the entire measuring element or a portion (or several portions) of the measuring element during the pressing operation may cause the visual indication. For example, a component of the measuring element, such as a pointer or some other indicator, may in connection with an increase of pressure move relative to a reference measuring scale on the measuring element, without subsequently returning as the pressure is being decreased, thus allowing a visible indication of the change of pressure in the pressure chamber.

An advantage of a visual indication is that the indication can be read directly on the measuring element. As a result, an operator can quickly and easily determine the maximum pressure achieved during the pressing operation and also establish that the product or the batch in question has in fact been subjected to pressure treatment.

Here it should be noted that also if the measuring element during measurement is placed, for example, in an obstructing holder or the like, this does not prevent the measuring element itself from presenting a remaining visible indication of the maximum value of the pressure achieved in the pressure chamber.

The measuring element is preferably arranged to be deformed in connection with a change of pressure, the deformation enabling indication of the maximum value of the pressure achieved in the pressure chamber. The deformation refers to the fact that at least parts of the measuring element change their configuration, such as direction of extension or volume. One type of deformation can be, for instance, shrinkage in connection with an increase of pressure or expansion in connection with a decrease of pressure.

In an advantageous embodiment of the invention, the isostatic press includes a measuring element which in turn includes a first part which is arranged to be deformed in connection with a change of pressure, and a second part which before the pressing operation has a first position relative to the first part. The first part is further arranged to set, during the pressing operation, the second part in relative motion to a second position, which is different from the first position. The relative motion is preferably produced by using the deformation of the first part. In other words, the first part can move relative to the surroundings while the second part is essentially immovable. Alternatively, the second part can move while the first part is essentially immovable. A further alternative is that both parts are movable relative to the surroundings.

It is the difference between the first and the second position of the second part, which, after the pressing operation, indicates the maximum value of the pressure achieved in the pressure chamber. This allows easy and reliable pressure indication since the change of position of the second part is proportional to the maximum value of the arisen pressure. Preferably, a scale or graduation is also arranged adjacent to the measuring element in order to further simplify the reading of the change of position of the second part and, thus, the maximum value of the pressure during the pressing operation. The remaining second position also gives the advantage that, in a subsequent situation, after the pressing operation, the maximum value of the achieved pressure can be read. In other words, the second part of the measuring element functions as a mechanical memory.

Besides presenting the maximum value of the pressure, the measuring element also indicates, as mentioned above, that the product or the batch in question has in fact been subjected to pressure treatment. This is advantageous in a large production plant where a large number of batches are circulating and where it may be difficult to tell by the appearance of the product in question whether it has been subjected to pressure treatment or not. By placing the measuring element together with the product or the batch, it will be easy, by checking the measuring element, to obtain an indication whether the batch has been subjected to pressure treatment or not.

In a further advantageous embodiment of the invention, the measuring element includes a reference point which limits the movement of the second part relative to the reference point in connection with a first change of pressure, such as an increase of pressure, but allows free movement of the second part relative to the reference point in connection with a second change of pressure, such as a decrease of pressure, contrary to the first change of pressure. After the pressing operation, the change of position of the second part relative to the reference point indicates the maximum value of the pressure achieved in the pressure chamber. The utilization of a reference point allows the maximum value of the pressure to be easily read since the distance between the reference point and the second part is proportional to the maximum value of the pressure. Owing to the reference point, the measuring element need not be recalibrated in additional measurements since in each measurement one starts from a given point, i.e. the reference point. By maximum value of the pressure is meant in this application text the maximum pressure achieved in the pressure chamber during a pressing operation.

To achieve a particularly functional design of the measuring element, the first part may be a body with two opposite ends, for example. The body can preferably have the shape of a long web, i.e. the thickness is considerably smaller than the length. Such an elongate web can be straight, such as a rod, an extended polyhedron or a band, or curved, such as in the form of a circular arc or a helix. However, it will be appreciated that many alternative shapes of the body are conceivable within the scope of the invention.

The body is in turn arranged inside a pipe. The pipe is in terms of size and shape adjusted to the shape and extent of the body and can thus be straight or curved. A given point of the pipe, such as one end of the pipe, suitably constitutes the reference point in the measuring element.

For sufficient resolution of the pressure indication, the body preferably exhibits a considerably greater degree of shrinkage in connection with an increase of pressure, and a considerably greater degree of expansion in connection with a decrease of pressure, than said pipe. As a result, if the deformation is used to affect the change of position of the second part, the second part will be moved in the pressing operation to such an extent that the difference between the first and the second position of the second part allows the maximum value of the pressure during the pressing operation to be indicated in a satisfactory manner. Therefore the pipe is suitably made of a material which is only negligibly affected by a change of pressure, for instance a metal, preferably stainless steel. The body is, however, preferably made of a material exhibiting a shrinkage of at least 0.5% at 6,000 bar, suitably at least 2% at 6,000 bar.

The resolution of the pressure reading is also affected by the length of the measuring element. For example, in connection with an increase of pressure, a longer measuring element shrinks, absolutely seen, more than a shorter measuring element, and thus a longer measuring element enables better resolution. Therefore the measuring element may be elongate, for example.

One end portion of the body is preferably in a suitable manner fixedly arranged in the pipe at the pipe end which is opposite to the reference point, for instance by way of a cotter pin or the like. With one end portion of the body fixed to one end of the pipe, the deformation of the body in connection with a change of pressure will only take place in essentially one direction relative to the reference point, which also results in better resolution in the reading.

The above-mentioned second part is preferably a clamp, which is resiliently arranged round the body so as to squeeze the body. This is preferable since the body in connection with a change of pressure is deformed both longitudinally and diametrically. The clamp is further of such a size that it cannot slide into the pipe. Before a pressing operation, the clamp is preferably arranged against one end of the pipe, which end constitutes the reference point. In this way, the movement of the clamp will, in connection with a subsequent increase of pressure, directly be limited by the pipe end.

In one more advantageous embodiment of the invention, the measuring element includes a third part, which is fixedly arranged on the first part, parallel thereto. The two parts can, for example, be interconnected in parallel at least at two spaced-apart points. Another alternative is that the two parts are fixedly arranged in each other in the longitudinal direction. The two parts can be fixed to each other, for example, by gluing.

Moreover, the third part exhibits a considerably smaller degree of shrinkage in connection with an increase of pressure, and a considerably smaller degree of expansion in connection with a decrease of pressure, than said first part. As a result, the first and the third part will be curved together in connection with a change of pressure. For example, in connection with an increase of pressure, the first part will shrink more than the third part. As such, tension arises in the interconnection, whereby the parts are bent together. In connection with a corresponding decrease of pressure, the first part will instead expand more than the third part. As such, the parts will be bent together, but in a direction opposite to the bending in connection with an increase of pressure. Bending in this application text does not require the parts to be straight in a starting position. In other words, bending can also imply that already bent parts are bent to a straighter shape.

Since the first and the third part are bent together in connection with a change of pressure, this change of shape can be used to make the second part move, the change of position of the second part indicating, after the pressing operation, the maximum value of the pressure achieved in the pressure chamber.

In this embodiment, the second part is suitably a pointer. The pointer abuts against the first part before the pressing operation, whereby the bending of the first and the third part is transferred to the pointer in connection with a change of pressure. As the pressure returns, the pointer remains in this position which indicates the maximum value of the pressure. Suitably a scale or a graduation is arranged at the pointer to facilitate the reading of the pressure.

If, in the above embodiment, the first part is made of an elastically deformable material, the first part resumes its original shape and position as the pressure returns. Alternatively, the first part is made of a plastically deformable material, in which case it essentially remains in the deformed state as the pressure returns. Whether the first part is made of an elastically or plastically deformable material has no direct effect on the indication of the maximum value of the pressure.

During a pressing cycle the pressure can be increased and decreased several times, and therefore it is advantageous to read the measuring element after the pressing operation to ensure that it is really the maximum value, seen over the entire pressing cycle, that is read and verified.

To allow the measuring element according to the invention to be used also in small isostatic presses, at least the first part, preferably the entire measuring element, is curved as at least one circular arc in an advantageous embodiment.

Preferably, the measuring element is curved so as to assume a helical shape. In this way, the measuring element requires less space in the longitudinal direction than an essentially straight extended measuring element. Another advantage is that a measuring element that is to be placed in a given space, by being helical, can be longer than an essentially straight measuring element, which allows better resolution with respect to the indication of the maximum value of the pressure.

The first part, preferably the entire measuring element, can alternatively be curved so as to assume the shape of a circle. This gives essentially the same advantages as those of a helical measuring element, but the circular shape also allows the measuring element to be easily placed, for example, essentially horizontally along the curved wall of an essentially circular pressure chamber. In other words, the curvature of the measuring element essentially follows the circumferential curvature of the pressure chamber wall. For example, a circular measuring element could be placed on the bottom of the pressure chamber or in the lid of the pressure chamber.

It will be understood that many other geometric shapes of the measuring element are feasible. However, the shape should be adjusted to prevent the deformation from being affected or limited in such a manner as to affect the quality of the reading.

The material of the first part should preferably exhibit elastic deformation, that is to say the deformation is not permanent but is fully recovered as the load is released, the load in this case being pressure. By using an elastically deformable material, the measuring element can, after resetting, advantageously be used in further pressing operations. The measuring element is easily reset by the second part, for instance a clamp or a pointer according to embodiment, being returned to its starting position, i.e. the position previously referred to as “first”.

It is also possible to use in the measuring element a material exhibiting plastic deformation, that is to say the deformation is permanent and the material remains in the deformed state also after the load has been released. However, the measuring element can then be used only once, or the material must, if possible, be reset to its original configuration to be used once more. In both cases, either a new material, or the reset material, should be checked before each new use to make sure that the material has the desired properties that are required for a correct measurement.

For the desired deformation to be achieved, which in turn allows indication of the maximum value of the pressure achieved in the pressure chamber, the first part is preferably made of a polymer. The first part exhibits preferably a shrinkage of at least about 0.5% at 6,000 bar, suitably at least 2% at 6,000 bar. Examples of particularly suitable polymers in this respect include, but are not limited to, UHMW-PE (ultrahigh molecular weight polyethylene). UHMW-PE exhibits on the one hand elastic deformation and, on the other, such a great degree of shrinkage (typically 3-4% at 6,000 bar one-dimensionally, i.e. along one axis) and expansion, respectively, in connection with changes of pressure that a satisfactory resolution of the pressure indication is obtained. Examples of other polymers that are conceivable for use as the first part are polyamide, PTFE, polycarbonate plastic, LD-PE, acryl, POM, acetate plastic, PET, styrene plastic, PVC. The first part can be formed, for example, by casting or cutting of a blank.

It will be appreciated that the first part may also consist of other materials having similar properties. Examples of other suitable materials include, but are not limited to, rubber, preferably hard rubber.

The isostatic press according to at least one embodiment of the invention can preferably be used for treatment of foods. The isostatic press according to at least one embodiment of the invention, however, is not limited to this range of application but can also be used for pressure treatment of other products, such as pharmaceutical preparations and cosmetics. Basically, the invention can be used to verify the maximum value of the pressure in all isostatic press applications, preferably when a liquid is used as pressure medium.

According to another aspect of at least one embodiment of the invention, a measuring element is provided for measuring the maximum value of the pressure achieved in a pressure chamber in connection with a pressing operation of an isostatic press comprising the pressure chamber. The measuring element includes a first part which is arranged to be deformed in connection with a change of pressure and a second part which before a pressing operation has a first position relative to the first part. The first part is further arranged to set, during the pressing operation, the second part in relative motion to a second position different from the first position. It is the difference between the first and the second position of the second part which, after the pressing operation, indicates the maximum value of the pressure achieved in the pressure chamber.

### BRIEF DESCRIPTION OF THE DRAWINGS

FIG. 1 is a schematic perspective view, partly in section, of an isostatic press according to an embodiment of the invention.

FIGS. 2a-2d illustrate schematically a measuring element according to an embodiment of the invention in connection with a pressing operation.

FIG. 3 is a schematic view of an advantageous embodiment of the measuring element according to the invention, the measuring element being helical.

FIG. 4 is a schematic view of another advantageous embodiment of the measuring element according to the invention, the measuring element being circular.

FIG. 5 is a schematic view of yet another advantageous embodiment of the measuring element according to the invention.

FIG. 6 is a cross-sectional view along line VI in FIG. 5.

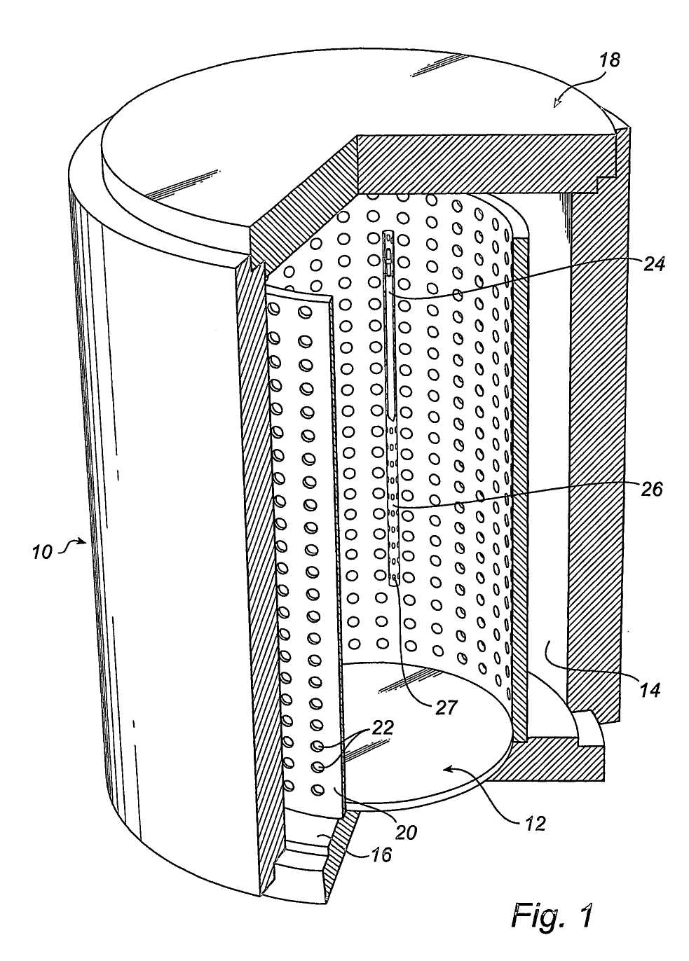

The same reference numerals are used for equivalent elements in FIGS. 1-6.

### DESCRIPTION OF EXAMPLE EMBODIMENTS

FIG. 1 is a schematic perspective view of an isostatic press 10 according to an embodiment of the invention. The isostatic press 10 includes a pressure chamber 12, inside which a high pressure, such as 2,000-15,000 bar, is generated for treatment of a product or a batch. The pressure chamber 12 is pressurized by a pressure medium, preferably a liquid. Moreover, the pressure chamber is defined by a cylindrical circumferential surface 14, a bottom 16 and a top lid 18. A load carrier 20 with the product or the batch that is to be subjected to pressure treatment is placed in the pressure chamber 12. The wall of the load carrier 20 is perforated with holes 22 so that the product that is to be subjected to pressure treatment will come into contact with the pressure medium.

The isostatic press 10 further includes a measuring element 24 which in FIG. 1 is arranged inside the load carrier 20, and a tubular holder 26 which is arranged vertically along one side of the load carrier 20. The holder 26 is closed at the bottom and open at the top, the measuring element 24 being placed inside said holder 26. The holder 26 is designed so that the measuring element 24 can easily be placed in the holder before a pressing operation, and so that the measuring element 24 is removable after the pressing operation. The holder 26 is perforated with holes 27 so that the measuring element 24 comes into contact with the pressure medium during a pressing operation, and thus is subjected to the same pressure as the product that is to be treated. The dimensions of the holder 26 are adapted so that the measuring element 24 fits said holder 26.

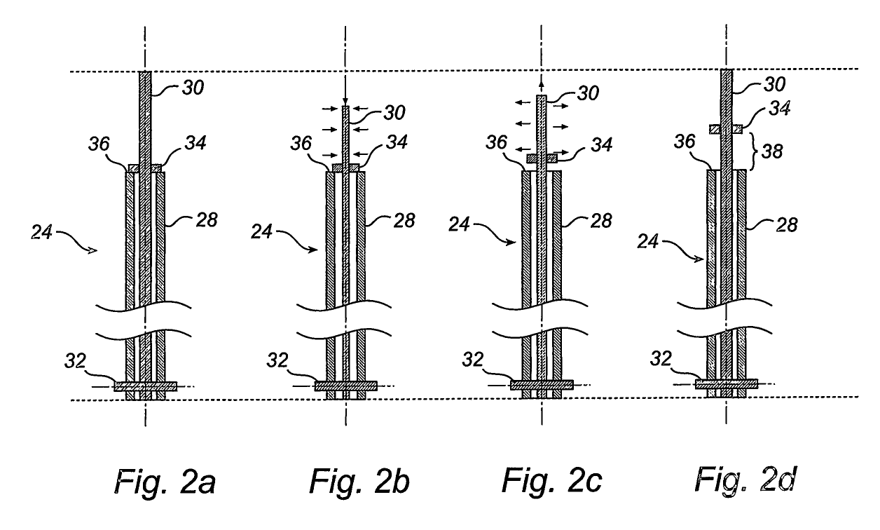

FIGS. 2a-2d illustrate schematically the measuring element 24 shown in FIG. 1 in connection with a pressing operation. In a pressing operation, the measuring element 24 is arranged so as to be subjected to the same pressure as the pressure chamber 12. The measuring element 24 includes a cylindrical elongate pipe 28 and a cylindrical rod 30 arranged in said pipe 28. One end portion of the rod 30 is fixedly arranged in one end portion of the pipe 28 by way of a cotter pin 32. The rod 30 is made of polymer while the pipe 28 is made of metal. A steel clamp 34 is arranged round the rod 30 in the rod end portion which in FIG. 2a projects from the pipe 28. The clamp 34, which is a radially inwardly flexible ring, squeezes the rod 30 and yet allows the rod 30 to slide in the clamp 34. However, the clamp 34 is dimensioned so as not be able to slide into the pipe 28.

In an initial position before the pressing operation (FIG. 2a), the clamp 34 is pressed up against the end 36 of the pipe 28 which is opposite to the end at which the rod 30 is fixedly mounted. With an increasing pressure in the isostatic press 10 (FIG. 2b), the polymer rod 30 will be deformed, in this case shrink, while the shrinkage of the metal pipe 28 is negligible. As the polymer rod 30 shrinks, the clamp 34 is prevented by the metal pipe 28 from accompanying the rod 30, and the polymer rod 30 slides inside the clamp 34. The polymer rod 30 shrinks both longitudinally and diametrically, but the resilient function of the clamp 34 prevents the clamp from sliding off the rod. Since one end portion of the rod 30 is fixedly arranged in the pipe 28, its shrinkage in the longitudinal direction will only occur from one direction.

As the pressure is then decreased in the isostatic press 10 (FIG. 2c), the polymer rod 30 will again be deformed, in this case expand, and resume its original shape and position. At the same time the clamp 34 accompanies the rod 30, whereby the clamp 34 is moved relative to the pipe 28. After the pressing operation, it is possible to establish, by measuring the distance 38 between the clamp 34 and the pipe end 36, i.e. the original position of the clamp, how much the rod 30 has shrunk during the pressing operation and, thus, also the maximum value of the pressure arisen in the pressing operation (FIG. 2d). By maximum value of the pressure is in this case meant the maximum pressure. After reading, the measuring element 24 can easily be reset by the clamp 34 again being pressed up against the pipe end 36, whereby the measuring element 24 can be used once more. It is to be noted that FIGS. 2a-2d are shown only for illustration purposes. Accordingly, the dimensions have been selected to elucidate the principle and, thus, are not necessarily to scale.

The measuring element 24 according to at least one embodiment of the invention is calibrated before use against another pressure sensor. The distance 38 between the clamp 34 and the pipe end 36 is established during several calibration cycles to find out which distances indicate the respective pressures.

In operation of the isostatic press 10, the distance is read after the pressing operation by an operator by way of a measuring device, such as a slide caliper. The reading can also be facilitated by the rod 30 being provided with a graduation or scale. For example, use can be made of color fields indicating the measured pressure. If, for example, less accuracy is required, the reading can, as an alternative, be made by directly looking at the rod and its graduation or scale, without using a slide caliper. The latter case is convenient if it is to be checked that the product or the batch has in fact been subjected to pressure treatment.

A pressing cycle typically involves an increase of pressure and a corresponding decrease of pressure. If the pressing cycle, however, includes a plurality of different increases of pressure and decreases of pressure, the measuring element according to the invention will indicate the individual maximum pressure that has arisen seen over the entire pressing cycle.

The rod 30 in FIGS. 2a-2d is, as mentioned above, made of a polymer, more specifically UHMW-PE (ultrahigh molecular weight polyethylene), which is a suitable polymer to be used at high pressure and when the pressure medium is a liquid. This material exhibits a sufficient degree of shrinkage in connection with an increase of pressure for the deflection to be read clearly and with sufficient resolution.

UHMW-PE also exhibits elastic deformation, that is to say the deformation is not permanent but is fully recovered as the load is released, the load in this case being pressure. By elastic deformation, the measuring element 24 can, after resetting, be used in further pressing operations.

The pipe 28 in FIGS. 2a-2d is made of metal, preferably stainless steel. Also other materials, which compared with the rod 30 exhibit a significantly smaller degree of shrinkage in connection with an increase of pressure, and a considerably smaller degree of expansion in connection with a corresponding decrease of pressure, could be used in at least one embodiment of the invention.

To achieve sufficient resolution in the reading of the maximum value of the pressure, the rod 30 is extended longitudinally. The pipe 28 has a corresponding shape and extent to allow the rod 30 to fit the pipe 28. The pipe 28 is suitably at least about 1 m long and has a diameter of about 10 mm. Even if the length of the rod affects the resolution, it is conceivable for both the rod and the pipe to be shorter and/or narrower.

The clamp 34 is also made of steel since steel is affected very little by changes of pressure. Moreover, the clamp 34 and the polymer rod 30 have a special surface finish so that the clamp 34 remains on the rod 30, but so that the rod 30 is nevertheless allowed to slide in the clamp 34 when the rod 30 changes its position while at the same time the clamp 34 is prevented from moving. In some cases, it may be advantageous to finish the surface of the rod 30 and the clamp 34 to achieve the desired frictional and sliding properties.

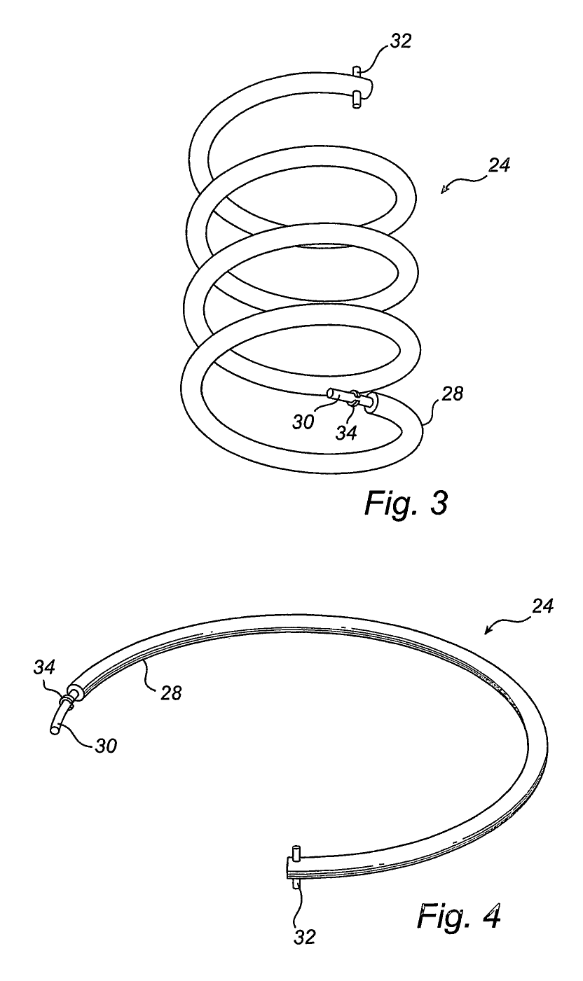

FIG. 3 is a schematic view of another example embodiment of the measuring element 24 according to the invention. In this embodiment, the measuring element 24 is helical, which allows it to be used in presses with a confined space.

In FIG. 4, the measuring element 24 according to at least one embodiment of the invention is circular. This shape allows the measuring element 24 to be placed, for example, horizontally along the wall of a pressure chamber. The measuring element in FIGS. 3 and 4 otherwise functions in the same way as the measuring element in FIGS. 2a-2d, i.e. it includes a steel pipe, a polymer rod arranged in the pipe and a clamp which is placed round the rod.

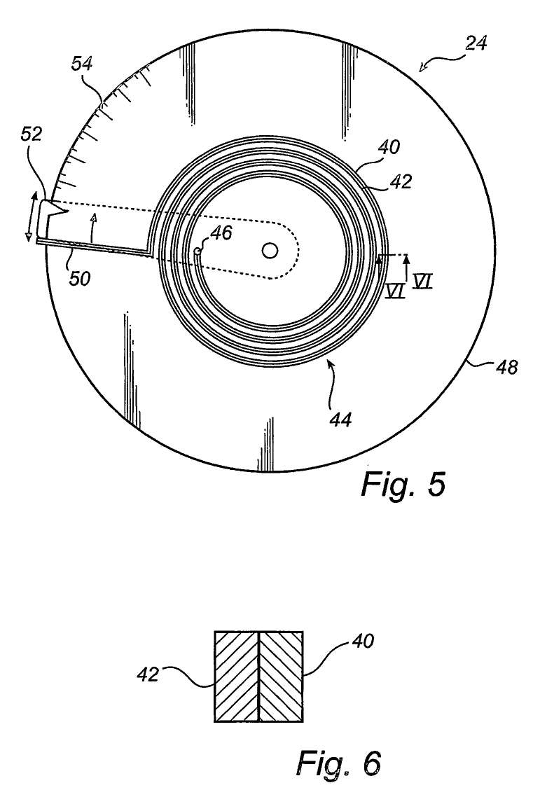

FIG. 5 schematically illustrates yet another embodiment of the invention. The measuring element 24 includes two bands 40 and 42 which are fixed to each other and wound into a helix 44. The inner end 46 of the helix 44 is fixed to a disc 48 and the outer end 50 of the helix 44 is folded outwards radially from the centre of the disc 48. The band 40 of the helix 44, which is the outer band relative to the outer edge of the disc 48, is made of a polymer, such as UHMW-PE, or some other solid material which is deformed in connection with changes of pressure. The inner band 42 is made of a material which is essentially unaffected by changes of pressure or at least less affected by changes of pressure than the material of the outer band 40. The inner band 42 can be made, for example, of silicone rubber, nitrile rubber or EPDM rubber. The outer band 40 and the inner band 42 are glued to each other. FIG. 6 is a cross-sectional view along line VI-VI in FIG. 5 which clearly shows the two different materials 40 and 42 of the helix 44.

On the opposite side of the disc 48, a rotatable pointer 52 is arranged in the centre of the disc 48. The pointer 52 is formed so as to project beyond the outer edge of the disc 48 and abuts against the outwardly folded outer end 50 of the helix 44.

As the pressure in the isostatic press 10 changes, in this case as the pressure increases, the helix 44 is turned outwards owing to the fact that the outer band 40 of the helix 44 shrinks to a greater degree than the inner band 42. The turning of the helix 44 is transferred to the pointer 52 which then remains in its position as the pressure decreases and the helix 44 resumes its original shape and returns to its starting position. By the pointer 52 remaining in its position, a remaining readable indication of the maximum value of the pressure is obtained. The disc 48 is further arranged with a scale or graduation 54, so that the pressure arisen during pressurization, in this case the maximum pressure, can easily be read.

The measuring element 24 according to at least one embodiment of the invention is calibrated before use against another pressure sensor. In calibration, the scale or graduation 54 is established on the disc 48 so as to allow easy reading of the point where the pointer 52 stands in order to verify the maximum pressure during the pressing operation.

In the embodiments described above and illustrated in the Figures, examples of measuring elements have thus been given, which are arranged to present, after the pressing operation, independently of electric peripheral equipment, a remaining readable indication of the maximum value of the pressure achieved in the pressure chamber. It will be appreciated that even if a change of pressure is visible on the measuring elements and the maximum value of the pressure can be read without electric equipment, it is possible, if desired, to use both non-electric and electric instruments for improved accuracy.

Although certain embodiments have been described above, the invention is not restricted to them. It will thus be understood that several modifications and variations can be provided without departing from the scope of the present invention as defined in the appended claims.

1. An isostatic press, comprising:
a pressure chamber adapted to be pressurized by a pressure medium; and
a measuring element, placed so as to be subjected to the same pressure as the pressure chamber,
the measuring element being arranged to present, after a pressing operation, independently of electric peripheral equipment, a remaining readable indication of the maximum value of the pressure achieved in the pressure chamber.

2. The isostatic press as claimed in claim 1, wherein the measuring element is arranged to present a visually readable indication of the maximum value of the pressure achieved in the pressure chamber.

3. The isostatic press as claimed in claim 1, wherein the measuring element is arranged to be deformed in connection with changes of pressure, the deformation enabling indication of the maximum value of the pressure achieved in the pressure chamber.

4. The isostatic press as claimed in claim 1, wherein the measuring element comprises,
a first part, arranged to be deformed in connection with a change of pressure,
a second part which, before a pressing operation, includes has a first position relative to the first part,
the first part being arranged to set, during the pressing operation, the second part in relative motion to a second position, which is different from the first position,
whereby the difference between the first and the second position of the second part, after the pressing operation, indicates the maximum value of the pressure achieved in the pressure chamber.

5. The isostatic press as claimed in claim 4, wherein the measuring element comprises,
a reference point which limits the movement of the second part relative to the reference point in connection with a first change of pressure, but allows free movement of the second part relative to the reference point in connection with a second change of pressure contrary to the first change of pressure,
whereby the difference between the first and the second position of the second part relative to the reference point, after the pressing operation, indicates the maximum value of the pressure achieved in the pressure chamber.

6. The isostatic press as claimed in claim 5, wherein the first part includes a body with two opposite ends, which is arranged inside a pipe, one end of the pipe being the reference point,
the body exhibiting a considerably greater degree of shrinkage in connection with an increase of pressure, and a considerably greater degree of expansion in connection with a decrease of pressure, than said pipe.

7. The isostatic press as claimed in claim 6, wherein one end portion of the body is fixedly arranged in said pipe.

8. The isostatic press as claimed in claim 6, wherein the second part is a clamp, resiliently arranged round the first part so as to squeeze the first part.

9. The isostatic press as claimed in claim 4, wherein the measuring element comprises,
a third part, fixedly arranged on the first part, parallel thereto, and which exhibits a smaller degree of shrinkage in connection with an increase of pressure, and a smaller degree of expansion in connection with a decrease of pressure, than said first part, the first and the third part being bent together in connection with a change of pressure.

10. The isostatic press as claimed in claim 4, wherein at least the first part is curved as at least one circular arc.

11. The isostatic press as claimed in claim 4, wherein the first part is rod-shaped.

12. The isostatic press as claimed in claim 4, wherein the first part is made of a material exhibiting elastic deformation.

13. The isostatic press as claimed in claim 4, wherein the first part is made of polymer.

14. A measuring element for measuring the maximum value of the pressure achieved in a pressure chamber in a pressing operation of an isostatic press which includes the pressure chamber, said measuring element comprising:
a first part arranged to be deformed in connection with a change of pressure;
a second part which, before a pressing operation, includes a first position relative to the first part,
the first part being arranged to set, during the pressing operation, the second part in relative motion to a second position different from the first position,
whereby the difference between the first and the second position of the second part, after the pressing operation, indicates the maximum value of the pressure achieved in the pressure chamber.

15. The measuring element as claimed in claim 14, comprising,
a reference point which limits the movement of the second part relative to the reference point in connection with a first change of pressure, but allows free movement of the second part relative to the reference point in connection with a second change of pressure contrary to the first change of pressure,
whereby the difference between the first and the second position of the second part relative to the reference point after the pressing operation indicates the maximum value of the pressure achieved in the pressure chamber.

16. The measuring element as claimed in claim 15, wherein the first part is a body with two opposite ends, which is arranged inside a pipe, whose one end constitutes the reference point,
the body exhibiting a considerably greater degree of shrinkage in connection with an increase of pressure, and a considerably greater degree of expansion in connection with a decrease of pressure, than said pipe.

17. The measuring element as claimed in claim 16, wherein one end portion of the body is fixedly arranged in said pipe.

18. The measuring element as claimed in claim 16, wherein the second part is a clamp, resiliently arranged round the first part so as to squeeze the first part.

19. The measuring element as claimed in claim 14, comprising:
a third part, fixedly arranged on the first part, parallel thereto, and which exhibits a considerably smaller degree of shrinkage in connection with an increase of pressure, and a considerably smaller degree of expansion in connection with a decrease of pressure, than said first part,
the first and the third part being bent together in connection with a change of pressure.

20. The measuring element as claimed in claim 14, wherein at least the first part is curved as at least one circular arc.

21. The measuring element as claimed in claim 14, wherein the first part is rod-shaped.

22. The measuring element as claimed in claim 14, wherein the first part is made of a material which exhibits elastic deformation.

23. The measuring element as claimed in claim 14, wherein the first part is made of a polymer.

24. (canceled)

25. The isostatic press as claimed in claim 1, wherein the pressure medium is a liquid.
